(19) United States
(12) Patent Application Publication
(10) Pub. No.: US 2021/0311621 A1
(43) Pub. Date: Oct. 7, 2021

(54) SWIPE GESTURES ON A VIRTUAL KEYBOARD WITH MOTION COMPENSATION

(71) Applicant: QUALCOMM Incorporated, San Diego, CA (US)

(72) Inventors: Mehul SOMAN, Sunnyvale, CA (US); Diyan TENG, Santa Clara, CA (US); Shashank NARAYANAN, Sunnyvale, CA (US)

(21) Appl. No.: 16/838,964

(22) Filed: Apr. 2, 2020

(51) Int. Cl. G06F 3/0488

(52) U.S. Cl. CPC G06F 3/04883

(57) ABSTRACT

Certain aspects of the present disclosure generally relate to an apparatus with a virtual keyboard being configured to compensate, or at least adjust, for motion of the apparatus during receipt of a swipe gesture. Other aspects of the present disclosure generally relate to a method for receiving data in an apparatus with a touchscreen. An exemplary data reception method generally comprises receiving a swipe gesture input sequence on a virtual keyboard of the touchscreen, wherein the apparatus with the touchscreen is undergoing motion during at least part of the swipe gesture input sequence; sensing at least one parameter indicative of the motion using at least one inertial sensor; and determining a character sequence based on the swipe gesture input sequence and the at least one parameter indicative of the motion.

### BACKGROUND

### Field of the Disclosure

Certain aspects of the present disclosure generally relate to data entry for electronic devices and, more particularly, to techniques and apparatus to compensate, or at least adjust, for motion during swipe gestures on virtual keyboards.

### Description of Related Art

Touchscreens enable users to interact directly with what is displayed, rather than using a mouse, touchpad, or other such input devices. Touchscreens are common in devices such as smartphones, tablets, game consoles, personal computers, electronic voting machines, Internet of Things (IoT) devices, and point-of-sale (POS) systems. The popularity of smartphones, tablets, and many types of information appliances is driving the demand and acceptance of common touchscreens for portable and functional electronics. Touchscreens are also found in the medical field, heavy industry, automated teller machines (ATMs), and kiosks such as museum displays or room automation, where keyboard and mouse systems do not allow a suitably intuitive, rapid, or accurate interaction by the user with the display's content.

Swipe gestures on virtual keyboards track finger or stylus movement gestures on a touch-sensing platform (e.g., smartphones and smart displays) to enter, select, and, in some cases, predict the words entered through the touchscreen. Swipe gestures can help remove the necessity to tap individual characters on a virtual keyboard (e.g., letters, numbers, symbols, etc.). Such technology may also be seen in industrial applications such as manufacturing lines, train stations, or any place that can have a smart display involving touchscreen input.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved swipe gesture tracking on virtual keyboards.

Certain aspects of the present disclosure provide an apparatus. The apparatus generally includes a processor, a touchscreen coupled to the processor, at least one inertial sensor coupled to the processor, and a memory coupled to the processor. The touchscreen is configured to receive a swipe gesture input sequence on a virtual keyboard of the touchscreen. The at least one inertial sensor is configured to sense at least one parameter indicative of motion of the apparatus during at least part of the swipe gesture input sequence. The memory is configured to store instructions, which when executed by the processor, cause the processor to perform operations for receiving data. The operations generally include determining a character sequence based on the swipe gesture input sequence and the at least one parameter indicative of the motion.

Certain aspects of the present disclosure provide a method for receiving data in an apparatus with a touchscreen. The method generally includes receiving a swipe gesture input sequence on a virtual keyboard of the touchscreen, wherein the apparatus with the touchscreen is undergoing motion during at least part of the swipe gesture input sequence; sensing at least one parameter indicative of the motion using at least one inertial sensor; and determining a character sequence based on the swipe gesture input sequence and the at least one parameter indicative of the motion.

Certain aspects of the present disclosure provide an apparatus. The apparatus generally includes means for receiving a swipe gesture input sequence on a virtual keyboard, wherein the apparatus is configured to undergo motion during at least part of the swipe gesture input sequence; means for sensing at least one parameter indicative of the motion; and means for determining a character sequence based on the swipe gesture input sequence and the at least one parameter indicative of the motion.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagrammatic representation of an example electronic device that includes a touchscreen displaying a virtual keyboard in accordance with certain aspects of the present disclosure.

FIG. 2 illustrates an example implementation of a system-on-a-chip (SOC).

FIGS. 3A and 3B are graphs depicting linear displacement and rotational data of a device while in a moving car.

FIG. 4 is a process flow diagram of example operations for inputting data with a swipe gesture on a touchscreen, in accordance with certain aspects of the present disclosure.

FIG. 5 is a block diagram of components for determining linear displacement based on accelerometer measurements, in accordance with certain aspects of the present disclosure.

FIG. 6 is a graph depicting example touch sensor data with and without lateral motion on a device with a touchscreen, in accordance with certain aspects of the present disclosure.

FIG. 7 is a flow diagram of example operations for receiving data in an apparatus with a touchscreen, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure relate to swipe gestures on virtual keyboards with motion compensation, or at least adjustment, for improved accuracy of virtual keyboard input while an apparatus with a touchscreen displaying the virtual keyboard is undergoing motion (e.g., linear displacement or angular rotation). Furthermore, certain aspects of the present disclosure may provide advantages for improving efficiency and accuracy of internal text prediction algorithms by redefining the search space of a swipe gesture, providing an alternate option to ignore swipe gestures altogether in response to fast and/or large movements, and improving touch area reliability overall.

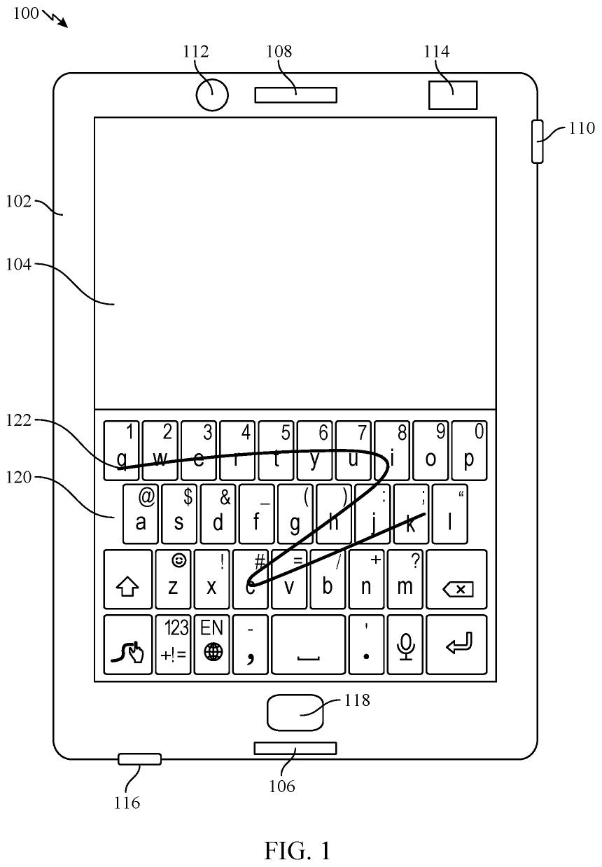

FIG. 1 is a diagrammatic representation of an example mobile device 100 that includes a touchscreen with a virtual keyboard according to some implementations. The mobile device 100 may be representative of, for example, various portable computing devices such as cellular phones, smartphones, multimedia devices, personal gaming devices, tablet computers, and laptop computers, among other types of portable computing devices. However, various implementations described herein are not limited in application to portable computing devices. Indeed, various techniques and principles disclosed herein may be applied in traditionally non-portable devices and systems, such as in computer monitors, television displays, kiosks, vehicle navigation devices, and audio systems, among other applications.

The mobile device 100 generally includes a housing (or “case”) 102 in or within which various circuits, sensors, and other electrical components reside. In the illustrated example implementation, the mobile device 100 also includes a touchscreen display 104. The mobile device 100 may include various other devices or components for interacting with, or otherwise communicating information to or receiving information from, a user. For example, the mobile device 100 may include one or more microphones 106, one or more speakers 108, and in some cases one or more at least partially mechanical buttons 110. The mobile device 100 may include various other components enabling additional features, such as one or more video or still-image cameras 112, one or more wireless network interfaces 114 (e.g., at least one antenna for Bluetooth, WiFi, or cellular) and one or more non-wireless interfaces 116 (for example, a universal serial bus (USB) interface or a high-definition multimedia interface (HDMI) port).

The mobile device 100 may include a sensor 118, which may be capable of sensing any of various suitable parameters, such as measuring linear acceleration or angular velocity, for example. The sensor 118, as shown, may be located at the bottom of the mobile device 100. However, the sensor 118 may be located in any suitable location on the mobile device 100. In some implementations, the sensor 118 may align with an X, Y, or Z axis of the mobile device 100. Furthermore, the mobile device 100 may include more than one such sensor.

The mobile device 100 may include, within the touchscreen display 104, a virtual keyboard 120. The virtual keyboard 120 may be configured to receive input from a user to produce text. In certain aspects, the virtual keyboard may include a virtual QWERTY keyboard, a virtual drawing pad configured to interpret traced shapes of letters and/or words, or any other suitable virtual keyboard configuration. The inputs from the user may include tapping the virtual keyboard 120 on a specific character, or traversing (“swiping”) a finger across the virtual keyboard in a continuous motion to make a swipe gesture 122 on the virtual keyboard 120. For example, the example swipe gesture 122 depicted in FIG. 1 traverses the virtual keyboard by starting at the letter ‘q,’ curving at the letters ‘i’ and ‘c,’ and terminating at the letter ‘k.’ This particular shape of the swipe gesture 122 may cause the internal algorithms associated with the virtual keyboard to determine that the character string to output on the display (and input to the mobile device 100) is the word ‘quick.’ The virtual line of the swipe gesture 122 may take any suitable shape based on the finger traversal or “swiping” of the user. In certain aspects, the virtual keyboard 120 may be configured with algorithms to predict text based, at least in part, on user input, type of user input, input history, grammar conventions, or any combination thereof. Furthermore, the user may optionally select for the virtual keyboard 120 to be capable of receiving “swiping” input. That is, the user can turn off the “swiping” functionality so the keyboard is only configured to receive the tap input for individual letters or other characters.

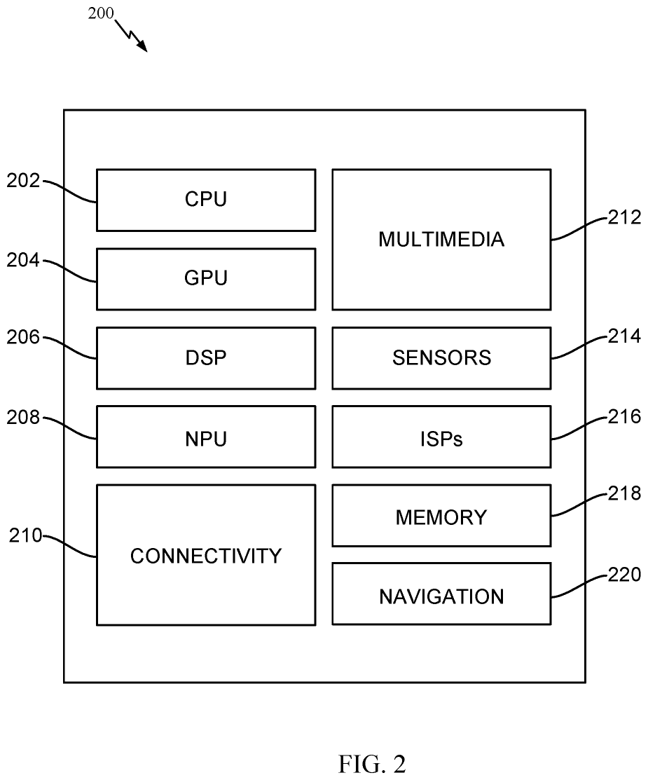

FIG. 2 illustrates an example implementation of a system-on-a-chip (SOC) 200, which may include a central processing unit (CPU) 202, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 208, in a memory block associated with a CPU 202, in a memory block associated with a graphics processing unit (GPU), in a memory block associated with a digital signal processor (DSP) 144, in a memory block 218, or may be distributed across multiple blocks. Instructions executed at the CPU 202 may be loaded from a program memory associated with the CPU 202 or may be loaded from a memory block 218.

The SOC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize swipe gestures. In one implementation, the NPU is implemented in the CPU, DSP, and/or GPU. The SOC 100A may also include a sensor processor 214, image signal processors (ISPs) 216, and/or navigation module 220, which may include a global positioning system (GPS). In certain aspects, the sensor processor 214 may receive input from one or more inertial sensors (e.g., sensor 118).

The SOC 200 may be based on an ARM instruction set. In an aspect of the present disclosure, the instructions loaded into the CPU 202 may comprise code to receive a swipe gesture input sequence on a virtual keyboard of the touchscreen. In addition, the instructions loaded into the CPU 202 may comprise code to sense at least one parameter indicative of motion. The instructions loaded into the CPU 202 may further comprise code to determine a character sequence based on the swipe gesture input sequence and the at least one parameter indicative of the motion.

### Example Motion Compensation for Swipe Gestures

When typing on a device with a touchscreen while in environments that involve movement (e.g., walking, riding in a car or other vehicle, or rollerblading), swipe gesture tracking on virtual keyboards (e.g., touchscreen keyboards) may be influenced by the motion of the device. Such motion may include, for example, vibration and/or relatively large transients when a vehicle hits a bump. The movement of the apparatus may be slight, such as in the case of small vibrations, but even the slightest perturbations of the device (and the resulting movements of a finger) may lead to inaccurate text prediction during swiping. In other words, the user's unintentional movement (due to a device's motion) while using the touchscreen of the device can lead to less accurate word predictions by the device compared to if the user were standing still or in/on a stationary object. Although a user may try to compensate for such movement (which may cause additional inadvertent movement of the device) while using swipe gestures to type on the virtual keyboard (e.g., holding the phone more tightly, slowing his or her walking pace, etc.), the movement can still cause inaccurate results in the word-prediction algorithms of the touchscreen keyboard, leading to the wrong word being typed, at least as interpreted by the device.

Accordingly, certain aspects of the present disclosure provide techniques for compensating, or at least adjusting, swipe gestures on virtual keyboards of an apparatus undergoing motion for improved accuracy of virtual keyboard typing to produce character sequences (e.g., words).

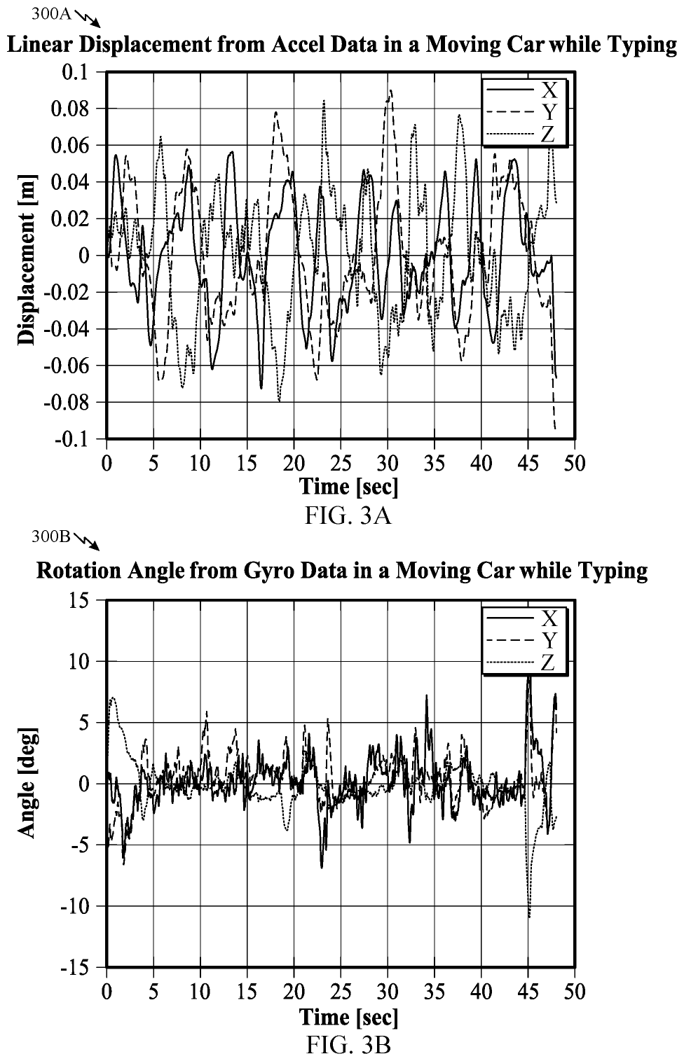

For example, certain devices include one or more sensors for sensing linear displacement in one or more directions and/or angular rotation. Movement of an apparatus (e.g., while a user is holding a mobile device or riding in or on the apparatus) with a touchscreen may be detected by, for example, one or more accelerometer(s) and/or gyroscope(s) of the apparatus. In certain aspects, the linear displacement(s) may be derived based on information from one or more accelerometers in or on the apparatus, while the angular rotation angle may be derived based on information from a gyroscope in or on the apparatus. As shown by the example data taken from accelerometers and a gyroscope of an electronic device in a moving car while typing in FIGS. 3A and 3B, the acceleration and gyroscopic information may be in three dimensions. The linear displacement, as shown by the displacement graph 300A, may be less than ±0.1 m, but even the slightest perturbations of the device (and the resulting movements of a finger) may lead to inaccurate text prediction during swiping. Similarly, as shown in the rotation graph 300B, an angular rotation may vary ±10°, which may also lead to inaccurate text prediction.

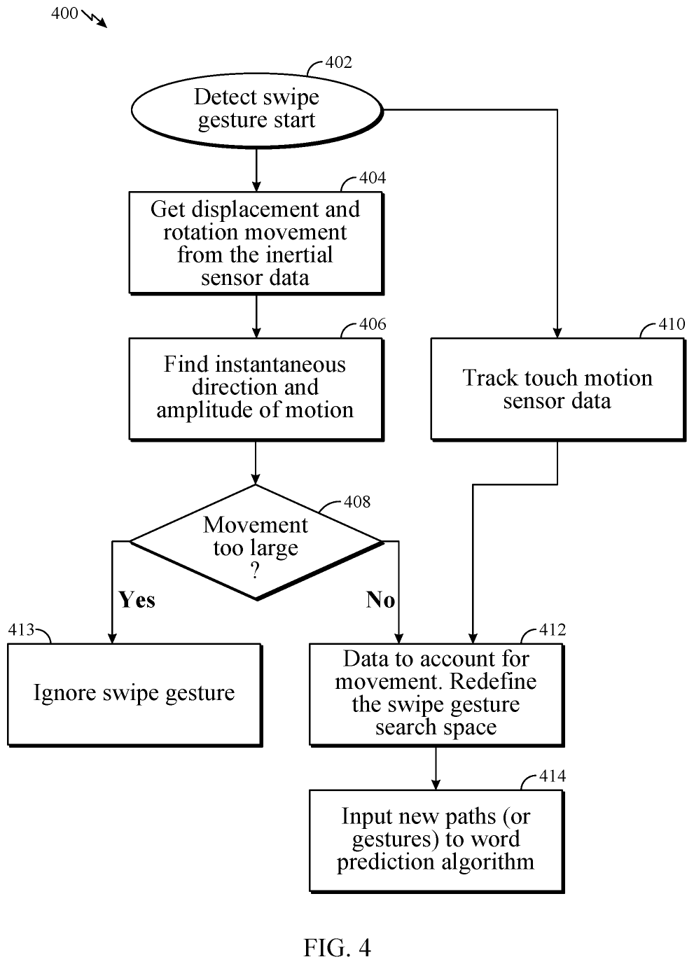

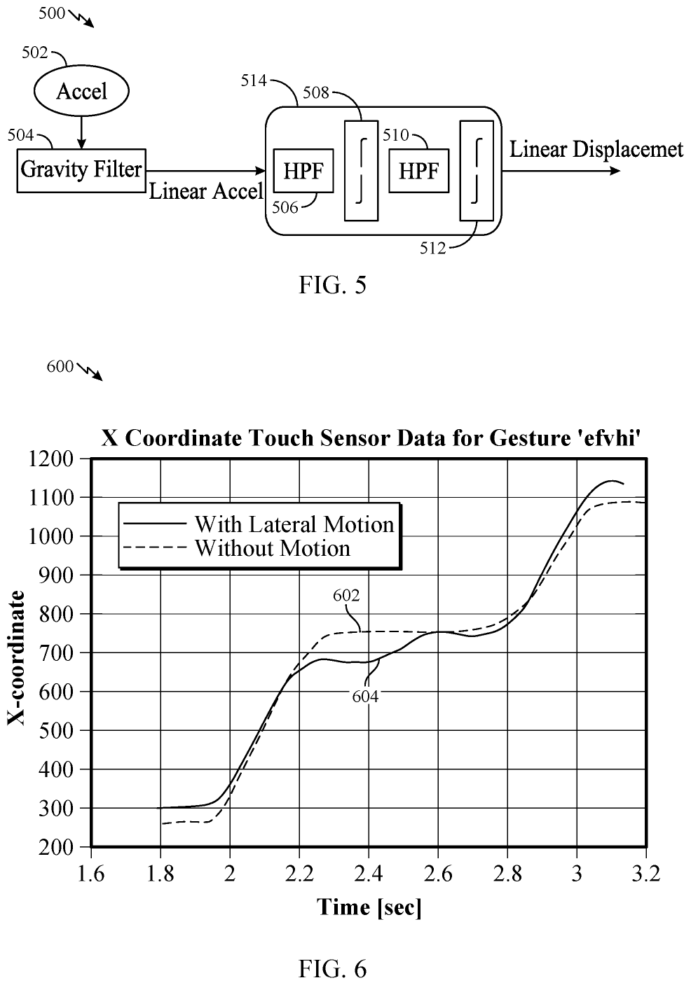

In certain aspects, the apparatus may be capable of deriving linear displacement(s) and/or a rotation angle based on input movement data from one or more accelerometers and/or a gyroscope of the apparatus, as further described herein with respect to FIG. 5. Such information may be used to compensate, or at least adjust, for an apparatus's movement while a user is swiping when the movement is small, and may be ignored when the movement is substantially large, as further described herein with respect to FIG. 4.

In certain aspects, the movement of the device can be used as input data to improve the accuracy of swipe gesture text input. Accordingly FIG. 4 is a process flow diagram of an example algorithm 400 for inputting data with a swipe gesture on a touchscreen. Starting at block 402, the user may input a swipe gesture, and the device (e.g., the mobile device 100 of FIG. 1 or a system in a vehicle) detects a start of the swipe gesture. Swipe gestures on virtual keyboards may be detected based on the amount of time the touch sensor is in use (e.g., a finger pressed on the keyboard) and/or significant continuous and unique motion (e.g., dragging a finger across the keyboard). The device may determine linear displacement and/or angular rotation information (as shown in more detail with respect to FIG. 5) from one or more inertial sensors (e.g., the sensor 118 of FIG. 1) at block 404. In certain aspects, the information from the one or more inertial sensors may be best suited to micro-dynamics (e.g., relatively small movement of the device). The device may also track touch motion sensor data from the swipe gesture on the virtual keyboard, at block 410. The tracking of touch sensor data may be represented in an XY coordinate plane mapped from the virtual keyboard. In certain aspects, the instantaneous direction and amplitude of motion may be found from the inertial sensor data, as shown at block 406.

If the movement found at block 404 is not too large (e.g., within a predetermined range or under a predetermined threshold) as determined at block 408, then the search space of the swipe gesture (referred to herein as the “swipe gesture search space”) may be redefined, as shown at block 412. That is, the original traced path from the swipe gesture input may be modified to compensate, or at least adjust, for the detected linear and/or angular movement. As a result, the search space may be decreased (or increased in some cases) based on the compensation or adjustment. When the path is redefined, the redefined path may be an input to the word-prediction algorithm of the virtual keyboard, as shown at block 414. By using the redefined path, the prediction algorithm may receive a more accurate representation of the swipe gesture input that is less prone to error caused by motion of the device while the user input the swipe gesture.

Alternatively, for certain aspects, if the movement is too large as determined at block 408, the swipe gesture input may be ignored at block 413. For example, a movement may be ignored when the movement has too large of an effect on the swipe gesture input by the user. For example, the movement may have a speed and/or displacement above a predetermined threshold or outside of a predetermined range.

The redefining of the paths (e.g., at block 412) may be done in various ways. For example, a deterministic approach may be used in certain aspects. In the deterministic approach, the modification of the swipe gesture (or path) may be accomplished by removing the displacement calculated from the sensor(s). That is, the swipe gesture path may be adjusted by the amount of displacement in a particular direction. For example, if the device is displaced in the positive X direction by a particular value, then the compensation (or adjustment) may be in the negative X direction by the particular value. This adjustment amount may be a single displacement value, an average of displacement values (e.g., taken during the swipe gesture input), a weighted average, or another statistically determined value based on the displacement values.

In other aspects, a filtering approach may be used to compensate, or at least adjust, for the motion of the device. The filtering approach may use sensor dynamics to smooth out the swipe gesture based on any of various suitable techniques. For example, a Kalman filter may be used to smooth out the swipe gesture. Also, known as linear quadratic estimation, a Kalman filter uses a series of measurements over time (containing statistical noise and other inaccuracies) and produces estimates of unknown variable by estimating a joint probability distribution over the variables for each timeframe. Alternatively or additionally, sequence-to-sequence neural nets may be used to smooth out the swipe gesture. Furthermore, the filtering approach may be based on the activity the device is involved in, such as an in-vehicle model or a walking model.

In other aspects, a machine-learning approach may be used to compensate, or at least adjust, for the motion of the device. The machine-learning approach may directly incorporate a sensor time series into a machine-learning algorithm for word prediction. In certain aspects, the machine-learning approach may take in large amounts of data to accomplish proper training of its motion compensation model.

As explained above, compensating, or at least adjusting, for device movement to improve the accuracy of swipe gestures on a virtual keyboard may use linear displacement(s) and/or angular rotation. Linear displacement and angular rotation may be calculated using data from an accelerometer and a gyroscope, respectively. Accordingly, FIG. 5 is an example block diagram 500 for determining linear displacement (in a particular direction) based on accelerometer measurements, in accordance with certain aspects of the present disclosure.

The data from the accelerometer 502 may be linear acceleration in one of three dimensions (e.g., the X, Y, or Z direction with respect to a device). Before undergoing the signal processing of block 514, the proper acceleration data from the accelerometer 502 may be pre-filtered to adjust for gravity (i.e., remove the effects of gravity). For example, if the accelerometer 502 in or on a device (e.g., the mobile device 100 of FIG. 1) is motionless on a table and oriented with its longitudinal axis in the Z direction, the accelerometer 502 itself may detect acceleration of 9.8 m/s² upwards (e.g., the positive Z direction). The gravity filter 504 may adjust the detected acceleration to reflect the true acceleration (e.g., a coordinate acceleration of 0 m/s²) of the device with the accelerometer 502. In block 514, the true linear acceleration determined by the gravity filter 504 may be filtered (e.g., by a high-pass filter (HPF) 506) to remove noise and detect higher frequency transient signals. The filtered signal may be integrated by an integrator 508 to determine a linear velocity signal. The linear velocity signal may then be optionally filtered by another HPF 510 and integrated again by another integrator 512, resulting in a linear displacement signal. Undergoing the filtering and integration of block 514 may allow linear displacement to be calculated from the true linear acceleration.

The angular displacement may be calculated in a similar fashion using data from a gyroscope. However, it should be noted that the gyroscope determines angular velocity, as opposed to angular acceleration. Therefore, the angular velocity from the gyroscope may be filtered and integrated just once to determine the angular displacement.

FIG. 6 is a graph 600 depicting example touch sensor data with and without lateral motion on a device with a touchscreen, in accordance with certain aspects of the present disclosure. As shown, the graph 600 includes lines depicting the X location of where a touchscreen is being interacted with respect to time as a finger traverses a virtual keyboard (e.g., the virtual keyboard 120 of FIG. 1) to touch the ‘e,’ ‘f,’ ‘v,’ ‘h,’ and ‘i’ keys. A first line 602 represents interaction with the touchscreen while the device with the touchscreen experiences no motion. A second line 604 represents interaction with the touchscreen while the device with the touchscreen experiences lateral motion. As shown, the second line 604 is not as smooth as the first line 602, which can be due to the lateral motion. The first line 602 between a time of 2.2 and 2.8 seconds is relatively flat. However, when there is lateral motion of the device, the smoothness of the second line 604 is proportionately impacted by the lateral motion. As explained above, a user may adjust his or her finger movement to compensate for some of the lateral motion, but doing so may not be enough to compensate for the lateral motion completely. In certain aspects, the search space for the swipe gesture may be modified by altering the second line 604 in a manner based on the sensed motion (e.g., proportional to the lateral motion).

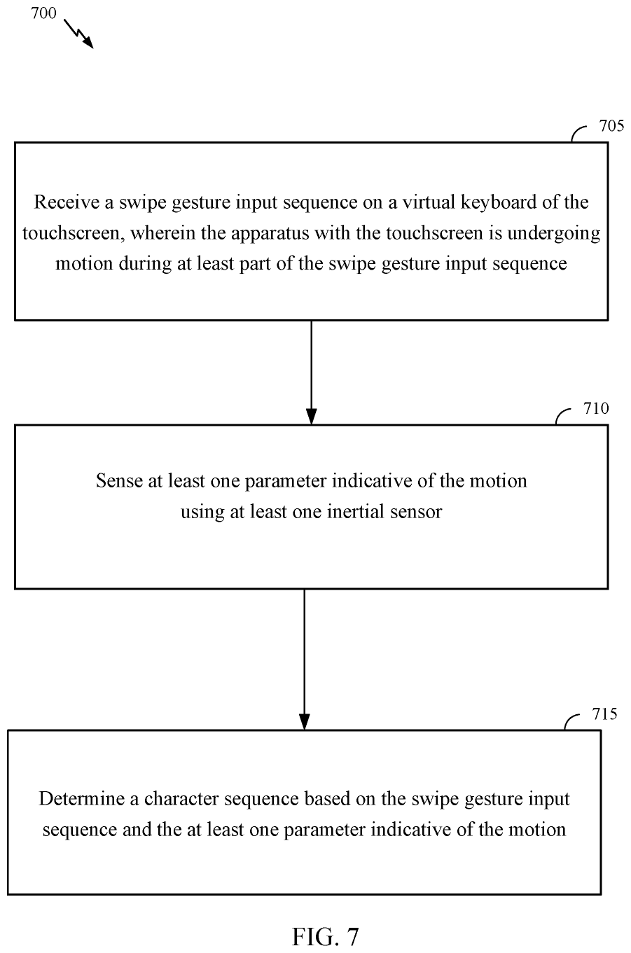

FIG. 7 is a flow diagram of example operations 700 for receiving data in an apparatus with a touchscreen, in accordance with certain aspects of the present disclosure. The operations may be performed, for example, by a processor (e.g., CPU 202) of the apparatus. The apparatus may be an electronic device (e.g., the mobile device 100 depicted in FIG. 1) or a vehicle (e.g., a car, truck, boat, aircraft, and the like).

The operations 700 may begin at block 705 by receiving a swipe gesture input sequence (e.g., the swipe gesture 122) on a virtual keyboard (e.g., the virtual keyboard 120) of the touchscreen. The apparatus with the touchscreen is undergoing motion during at least part of the swipe gesture input sequence. For example, the motion may entail vibration of the apparatus with the touchscreen.

Referring to block 710, the operations 700 continue by sensing at least one parameter indicative of the motion using at least one inertial sensor. As used herein, “sensing” may include sensing with a sensor associated with the apparatus and/or receiving a signal indicative of a parameter sensed by a sensor, whether associated with the apparatus or not.

The operations 700 continue to block 715 by determining a character sequence based on the swipe gesture input sequence and the at least one parameter indicative of the motion.

In certain aspects, the at least one inertial sensor includes an accelerometer. In this case, the at least one parameter may include a linear acceleration along an axis (e.g., the longitudinal axis) of the accelerometer. The axis of the accelerometer may be aligned with an X, Y, or Z axis of the apparatus.

In certain aspects, the at least one inertial sensor comprises an accelerometer. In this case, the at least one parameter may include an angular velocity.

In certain aspects, the determining of block 715 may include determining the character sequence by adjusting a search distance of a swipe gesture search space for at least one character in the character sequence based on the swipe gesture input sequence and the at least one parameter indicative of the motion. For example, the adjusting may be done by removing a displacement from the swipe gesture search space for the at least one character in the character sequence and the displacement is based on the at least one parameter indicative of the motion. As another example, the adjusting may be done by using one or more filters (e.g., a Kalman filter) to smooth out the swipe gesture search space. In other aspects, the adjusting may entail adjusting by using a machine-learning approach to adjust the search distance of the swipe gesture search space.

In certain aspects, the at least one inertial sensor comprises an accelerometer, and, in this case, the at least one parameter may include a linear acceleration along an axis of the accelerometer. In this case, the adjusting may be done by integrating the linear acceleration to generate a velocity and integrating the velocity to generate the displacement.

In certain aspects, the character sequence comprises a word. Furthermore, the operations 700 may further include determining the character sequence comprises using a word prediction algorithm based on the adjusted search distance of the swipe gesture search space.

In certain aspects, the operations 700 may further include determining that a first parameter indicative of the motion is above a first threshold and determining that a second parameter indicative of the motion is below a second threshold. In this case, determining the character sequence may entail determining the character sequence based on the swipe gesture input sequence and the second parameter while ignoring the first parameter.

In certain aspects, the at least one inertial sensor comprises a first set of one or more inertial sensors associated with the apparatus. For certain aspects, the at least one inertial sensor may also include a second set of one or more inertial sensors associated with a vehicle, the vehicle being different from the apparatus. In this case, the second set of sensors may transmit or otherwise send data to the apparatus for use in determining the character sequence at block 715, in combination with data from the first set.

For other aspects, the at least one inertial sensor comprises at least one vehicle-mounted inertial sensor. In this case, the apparatus may be a vehicle.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

Certain aspects of the present disclosure provide an apparatus. The apparatus generally includes means for receiving (e.g., the touchscreen display 104) a swipe gesture input sequence on a virtual keyboard, wherein the apparatus is configured to undergo motion during at least part of the swipe gesture input sequence; means for sensing (e.g., the sensor 118, the accelerometer 502, and/or the sensor processor 214) at least one parameter indicative of the motion; and means for determining (e.g., the CPU 202) a character sequence based on the swipe gesture input sequence and the at least one parameter indicative of the motion.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes and variations may be made in the arrangement, operation and details of the methods and apparatus described above without departing from the scope of the claims.

1. A method of receiving data in an apparatus with a touchscreen, comprising:
receiving a swipe gesture input sequence on a virtual keyboard of the touchscreen, wherein the apparatus with the touchscreen is undergoing motion during at least part of the swipe gesture input sequence;
sensing at least one parameter indicative of the motion using at least one inertial sensor; and
determining a character sequence based on the swipe gesture input sequence and the at least one parameter indicative of the motion.

2. The method of claim 1, wherein the at least one inertial sensor comprises an accelerometer and wherein the at least one parameter comprises a linear acceleration along an axis of the accelerometer.

3. The method of claim 1, wherein the at least one inertial sensor comprises a gyroscope and wherein the at least one parameter comprises an angular velocity.

4. The method of claim 1, wherein the motion comprises vibration of the apparatus with the touchscreen.

5. The method of claim 1, wherein determining the character sequence comprises adjusting a search distance of a swipe gesture search space for at least one character in the character sequence based on the swipe gesture input sequence and the at least one parameter indicative of the motion.

6. The method of claim 5, wherein the adjusting comprises removing a displacement from the swipe gesture search space for the at least one character in the character sequence and wherein the displacement is based on the at least one parameter indicative of the motion.

7. The method of claim 6, wherein the at least one inertial sensor comprises an accelerometer, wherein the at least one parameter comprises a linear acceleration along an axis of the accelerometer, and wherein the adjusting comprises:
integrating the linear acceleration to generate a velocity; and
integrating the velocity to generate the displacement.

8. The method of claim 5, wherein the adjusting comprises using one or more filters to smooth out the swipe gesture search space.

9. The method of claim 8, wherein the one or more filters comprise a Kalman filter.

10. The method of claim 5, wherein the adjusting comprises using a machine-learning approach to adjust the search distance of the swipe gesture search space.

11. The method of claim 5, wherein the character sequence comprises a word and wherein determining the character sequence comprises using a word prediction algorithm based on the adjusted search distance of the swipe gesture search space.

12. The method of claim 1, further comprising:
determining that a first parameter indicative of the motion is above a first threshold; and
determining that a second parameter indicative of the motion is below a second threshold, wherein determining the character sequence comprises determining the character sequence based on the swipe gesture input sequence and the second parameter while ignoring the first parameter.

13. The method of claim 1, wherein the at least one inertial sensor comprises a first set of one or more inertial sensors associated with the apparatus.

14. The method of claim 13, wherein the at least one inertial sensor further comprises a second set of one or more inertial sensors associated with a vehicle, the vehicle being different from the apparatus.

15. The method of claim 1, wherein the at least one inertial sensor comprises at least one vehicle-mounted inertial sensor.

16. The method of claim 15, wherein the apparatus is a vehicle.

17. An apparatus comprising:
a processor;
a touchscreen coupled to the processor and configured to receive a swipe gesture input sequence on a virtual keyboard of the touchscreen;
at least one inertial sensor coupled to the processor and configured to sense at least one parameter indicative of motion of the apparatus during at least part of the swipe gesture input sequence; and
a memory coupled to the processor and configured to store instructions, which when executed by the processor, cause the processor to perform operations for receiving data, the operations comprising determining a character sequence based on the swipe gesture input sequence and the at least one parameter indicative of the motion.

18. The apparatus of claim 17, wherein the at least one inertial sensor comprises an accelerometer and wherein the at least one parameter comprises a linear acceleration along an axis of the accelerometer.

19. The apparatus of claim 17, wherein the at least one inertial sensor comprises a gyroscope and wherein the at least one parameter comprises an angular velocity.

20. The apparatus of claim 17, wherein the motion comprises vibration of the apparatus with the touchscreen.
